(19) United States
(12) Patent Application Publication
(10) Pub. No.: US 2015/0162613 A1
(43) Pub. Date: Jun. 11, 2015

(54) POWER STORAGE DEVICE POSITIVE ELECTRODE AND PRODUCTION METHOD THEREFOR, POSITIVE ELECTRODE ACTIVE SUBSTANCE FOR POWER STORAGE DEVICE AND PRODUCTION METHOD THEREFOR, AND POWER STORAGE DEVICE

(71) Applicant: NITTO DENKO CORPORATION, Ibaraki-shi, Osaka (JP)

(72) Inventors: Yohei Ando, Ibaraki-shi (JP); Yutaka Kishii, Ibaraki-shi (JP); Masao Abe, Ibaraki-shi (JP); Yoshihiro Uetani, Ibaraki-shi (JP)

(73) Assignee: NITTO DENKO CORPORATION, Ibaraki-shi, Osaka (JP)

(21) Appl. No.: 14/418,005

(22) PCT Filed: Aug. 7, 2013
(86) PCT No.: PCT/JP2013/071424

§ 371 Date: Jan. 28, 2015

(30) Foreign Application Priority Data
Aug. 8, 2012 (JP) 2012-176291
Aug. 6, 2013 (JP) 2013-163441

(51) Int. Cl. H01M 4/60; B02C 19/06; H01M 4/04

(52) U.S. Cl. CPC H01M 4/606; H01M 4/0433; B02C 19/06; H01M 2004/028

(57) ABSTRACT

A power storage device positive electrode which ensures development of a higher capacity at the initial stage of a charge/discharge process and a higher capacity density is provided. The power storage device positive electrode contains an electrically conductive polymer as a positive electrode substance, where the electrically conductive polymer is present in a particulate form having a median diameter of not greater than 5 μm.

### TECHNICAL FIELD

The present invention relates to a power storage device positive electrode and a production method therefor, a positive electrode active substance for a power storage device and a production method therefor, and a power storage device. More specifically, the present invention relates to a power storage device positive electrode and a production method therefor, a positive electrode active substance for a power storage device and a production method therefor, and a power storage device, which ensure development of a higher capacity at the initial stage of a charge/discharge process and a higher capacity density.

### BACKGROUND ART

With recent improvement and advancement of electronics technology for mobile electronic apparatuses such as mobile PCs, mobile phones and personal digital assistants (PDAs), secondary batteries and the like which can be repeatedly charged and discharged are widely used as power storage devices for these electronic apparatuses. It is desirable to increase the capacity of an electrode material for these secondary batteries and other electrochemical power storage devices.

An electrode for such a power storage device contains an active substance which is capable of ion insertion/desertion. The ion insertion/desertion of the active substance is also referred to as doping/dedoping (or dope/dedope), and the doping/dedoping amount per unit molecular structure is referred to as dope percentage. A material having a higher dope percentage can provide a higher capacity battery.

From an electrochemical viewpoint, the capacity of the battery can be increased by using an electrode material having a greater ion insertion/desertion amount. In lithium secondary batteries which are attractive power storage devices, more specifically, a graphite-based negative electrode capable of lithium ion insertion/desertion is used in which about one lithium ion is inserted and deserted with respect to six carbon atoms to provide a higher capacity.

Of these lithium secondary batteries, a lithium secondary battery which has a higher energy density and, therefore, is widely used as the power storage device for the aforesaid electronic apparatuses includes a positive electrode prepared by using a lithium-containing transition metal oxide such as lithium manganate or lithium cobaltate, and a negative electrode prepared by using a carbon material capable of lithium ion insertion/desertion, the positive electrode and the negative electrode being disposed in opposed relation in an electrolytic solution.

However, this lithium secondary battery, which generates electric energy through an electrochemical reaction, disadvantageously has a lower power density because of its lower electrochemical reaction rate. Further, the lithium secondary battery has a higher internal resistance, so that rapid discharge and rapid charge of the secondary battery are difficult. In addition, the secondary battery generally has a shorter service life, i.e., a poorer cycle characteristic, because the electrodes and the electrolytic solution are degraded due to the electrochemical reaction associated with the charge and the discharge.

There is also known a lithium secondary battery in which an electrically conductive polymer such as a polyaniline containing a dopant is used as a positive electrode active substance to cope with the aforesaid problem (see PLT1).

In general, however, the secondary battery employing the electrically conductive polymer as the positive electrode active substance is of anion migration type in which the electrically conductive polymer is doped with an anion in a charge period and dedoped with the anion in a discharge period. Where a carbon material or the like capable of lithium ion insertion/desertion is used as a negative electrode active substance, therefore, it is impossible to provide a rocking chair-type secondary battery of cation migration type in which the cation migrates between the electrodes in the charge/discharge. That is, the rocking chair-type secondary battery is advantageous in that only a smaller amount of the electrolytic solution is required, but the secondary battery employing the electrically conductive polymer as the positive electrode active substance cannot enjoy this advantage. Therefore, it is impossible to contribute to the size reduction of the power storage device.

To cope with this problem, a secondary battery of cation migration type is proposed which is substantially free from change in the ion concentration of the electrolytic solution without the need for a greater amount of the electrolytic solution, and aims at improving the capacity density and the energy density per unit volume or per unit weight. This secondary battery includes a positive electrode prepared by using an electrically conductive polymer containing a polymer anion such as polyvinyl sulfonate as a dopant, and a negative electrode of metal lithium (see PLT2).

### RELATED ART DOCUMENT

### Patent Document

PATENT DOCUMENT 1: JP-A-HEI3(1991)-129679

PATENT DOCUMENT 2: JP-A-HEI1(1989)-132052

### SUMMARY OF INVENTION

However, the secondary batteries described in PLT1 and PLT2 are disadvantageously lower in capacity density and energy density than the lithium secondary battery which employs the lithium-containing transition metal oxide such as lithium manganate or lithium cobaltate as the electrode active substance for the positive electrode. The secondary batteries described in PLT1 and PLT2 fail to develop a sufficient capacity density at the initial stage of the charge/discharge process immediately after the assembly of the battery, requiring to perform the charge/discharge process at a lower rate (0.05 C) several times.

In view of the foregoing, it is an object of the present invention to provide a power storage device positive electrode and a production method therefor, a positive electrode active substance for a power storage device and a production method therefor, and a power storage device, which ensure development of a higher capacity at the initial stage of a charge/discharge process and a higher capacity density.

According to a first aspect of the present invention to achieve the aforementioned object, there is provided a power storage device positive electrode, which includes an electrically conductive polymer as a positive electrode active substance, wherein the electrically conductive polymer is present in a particulate form having a median diameter of not greater than 5 μm.

According to a second aspect of the present invention, there is provided a production method for a power storage device positive electrode, which includes the steps of: adding at least an electrically conductive agent, a binder and water to particles of a positive electrode active substance including an electrically conductive polymer to prepare a slurry; and forming the slurry into a sheet; wherein the electrically conductive polymer is electrically conductive polymer particles prepared by pulverizing the electrically conductive polymer to a median diameter of not greater than 5 μm by means of a JET mill pulverizer.

According to a third aspect of the present invention, there is provided a positive electrode active substance for a power storage device, the positive electrode active substance including particles of an electrically conductive polymer having a median diameter of not greater than 5 μm.

According to a fourth aspect of the present invention, there is provided a method for producing a positive electrode active substance including an electrically conductive polymer for a power storage device, the method including the step of using particles of the electrically conductive polymer prepared by pulverizing the electrically conductive polymer to a median diameter of not greater than 5 μm by means of a JET mill pulverizer.

According to a fifth aspect of the present invention, there is provided a power storage device which includes: an electrolyte layer; and a positive electrode and a negative electrode provided in opposed relation with the electrolyte layer interposed therebetween; wherein the positive electrode contains electrically conductive polymer particles having a median diameter of not greater than 5 μm as a positive electrode active substance.

The inventors of the present invention conducted intensive studies on a positive electrode to provide a power storage device which is capable of developing a higher capacity at the initial stage of the charge/discharge process and has a higher capacity density. Then, the inventors conducted various experiments, while focusing on the particle size distribution of particles of an electrically conductive polymer to be employed as a positive electrode active substance (hereinafter sometimes referred to as “electrically conductive polymer particles”). As a result, the inventors found that, where the electrically conductive polymer particles having a median diameter (d50) of not greater than 5 μm are used, the power storage device is capable of developing a higher capacity at the initial stage of the charge/discharge process, thereby achieving the intended object. This is supposedly, but not clearly, because the electrically conductive polymer fine particles having a median diameter of not greater than 5 μm for use as the positive electrode active substance improve the diffusion of an electrolytic solution and ions to center portions (inner portions) of the electrically conductive polymer particles.

As described above, the power storage device positive electrode contains the fine particles of the electrically conductive polymer having a median diameter of not greater than 5 μm as the positive electrode active substance. Therefore, a power storage device employing this power storage device positive electrode is capable of developing a higher initial capacity in the initial charge/discharge, and has a higher capacity density per unit weight of the active substance.

Where the electrically conductive polymer is a polyaniline or a polyaniline derivative, the capacity density and the energy density are further improved.

### BRIEF DESCRIPTION OF DRAWING

FIG. 1 is a sectional view of an exemplary power storage device.

### DESCRIPTION OF EMBODIMENTS

An embodiment of the present invention will hereinafter be described in detail by way of example but not by way of limitation.

The power storage device positive electrode (hereinafter sometimes referred to simply as “positive electrode”) contains an electrically conductive polymer as a positive electrode active substance, wherein the electrically conductive polymer is present in a particulate form having a median diameter of not greater than 5 μm.

<Electrically Conductive Polymer>

The electrically conductive polymer is herein defined as any of polymers which have an electrical conductivity variable due to insertion or desertion of ion species with respect to the polymer in order to compensate for change in electric charge to be generated or removed by an oxidation reaction or a reduction reaction occurring in a main chain of the polymer.

The polymer has a higher electrical conductivity in a doped state, and has a lower electrical conductivity in a dedoped state. Even if the electrically conductive polymer loses its electrical conductivity due to the oxidation reaction or the reduction reaction to be thereby electrically insulative (in the dedoped state), the polymer can reversibly have an electrical conductivity again due to the oxidation/reduction reaction. Therefore, the electrically insulative polymer in the dedoped state is herein also classified into the category of the electrically conductive polymer.

A preferred example of the electrically conductive polymer is a polymer containing a dopant of a protonic acid anion selected from the group consisting of inorganic acid anions, aliphatic sulfonate anions, aromatic sulfonate anions, polymeric sulfonate anions and polyvinyl sulfate anion. Another preferred example of the electrically conductive polymer is a polymer obtained in the dedoped state by dedoping the electrically conductive polymer described above.

Specific examples of the electrically conductive polymer include electrically conductive polymer materials such as polyacetylene, polypyrrole, polyaniline, polythiophene, polyfuran, polyselenophene, polyisothianaphthene, polyphenylene sulfide, polyphenylene oxide, polyazulene, poly(3,4-ethylenedioxythiophene) and substitution products of these polymers, and carbon materials such as polyacene, graphite, carbon nanotube, carbon nanofiber and graphene. Particularly, polyaniline, polyaniline derivatives, polypyrrole and polypyrrole derivatives each having a higher electrochemical capacity are preferably used, and polyaniline and polyaniline derivatives are further preferably used.

Polyaniline is a polymer prepared by electrolytic polymerization or chemical oxidation polymerization of aniline, and the polyaniline derivatives are polymers prepared by electrolytic polymerization or chemical oxidation polymerization of aniline derivatives.

Examples of the aniline derivatives include aniline derivatives prepared by substituting aniline at positions other than the 4-position thereof with at least one substituent selected from the group consisting of alkyl groups, alkenyl groups, alkoxy groups, aryl groups, aryloxy groups, alkylaryl groups, arylalkyl groups and alkoxyalkyl groups. Specific examples of the aniline derivatives include o-substituted anilines such as o-methylaniline, o-ethylaniline, o-phenylaniline, o-methoxyaniline and o-ethoxyaniline, and m-substituted anilines such as m-methylaniline, m-ethylaniline, m-methoxyaniline, m-ethoxyaniline and m-phenylaniline, which may be used either alone or in combination. Though having a substituent at the 4-position, p-phenylaminoaniline is advantageously used as the aniline derivative because polyaniline can be provided by the oxidation polymerization of p-phenylaminoaniline.

“Aniline or an aniline derivative” is herein referred to simply as “aniline” unless otherwise specified. “A polyaniline or a polyaniline derivative” is herein referred to simply as “polyaniline” unless otherwise specified. Even if a polymer for the electrically conductive polymer is prepared from an aniline derivative, therefore, the resulting polymer is referred to as “electrically conductive polyaniline.”

[Preparation of Electrically Conductive Polymer]

As well known, the electrically conductive polyaniline can be prepared by electrolytic polymerization of aniline in a proper solvent in the presence of a protonic acid or by chemical oxidation polymerization of aniline with the use of an oxidizing agent. Preferably, the electrically conductive polyaniline is prepared by the oxidation polymerization of aniline in a proper solvent in the presence of a protonic acid with the use of an oxidizing agent. In general, water is used as the solvent, but other usable examples of the solvent include solvent mixtures of water soluble organic solvents and water, and solvent mixtures of water and nonpolar organic solvents. In this case, a surface active agent is used in combination with the solvent.

More specifically, where water is used as the solvent for the oxidation polymerization of aniline, for example, aniline is polymerized in water in the presence of a protonic acid with the use of a chemical oxidizing agent through the chemical oxidation polymerization. The chemical oxidizing agent may be water-soluble or water-insoluble.

Preferred examples of the oxidizing agent include ammonium peroxodisulfate, hydrogen peroxide, potassium bichromate, potassium permanganate, sodium chlorate, cerium ammonium nitrate, sodium iodate and iron chloride.

The amount of the oxidizing agent to be used for the oxidation polymerization of aniline is related to the yield of the electrically conductive polyaniline. For stoichiometric reaction of aniline, the oxidizing agent is preferably used in an amount (2.5/n) times the molar amount of aniline to be used, wherein n is the number of electrons required for the reduction of one mole of the oxidizing agent. In the case of ammonium peroxodisulfate, for example, n is 2 as can be understood from the following reaction formula:

(NH₄)₂S₂O₈+2e→2NH₄⁺+2SO₄²⁻

However, the amount of the oxidizing agent to be used may be slightly smaller than the amount (2.5/n) times the molar amount of aniline to be used, i.e., 30 to 80% of the amount (2.5/n) times the molar amount of aniline to be used, for suppression of peroxidization of the polyaniline.

In the production of the electrically conductive polyaniline, the protonic acid serves to dope the produced polyaniline for imparting the polyaniline with electrical conductivity and for dissolving aniline in the form of salt in water. The protonic acid also serves to maintain the polymerization reaction system at a strong acidity level, preferably, with a pH of not higher than 1. Therefore, the amount of the protonic acid is not particularly limited in the production of the electrically conductive polyaniline, as long as the above purposes can be achieved. In general, the amount of the protonic acid is 1.1 to 5 times the molar amount of aniline. If the amount of the protonic acid is excessively great, the costs of a waste liquid treatment required after the oxidation polymerization of aniline is needlessly increased. Therefore, the amount of the protonic acid is preferably 1.1 to 2 times the molar amount of aniline. Thus, a protonic acid having a strong acidity and an acid dissociation constant pKa of less than 3.0 is preferably used.

Preferred examples of the protonic acid having an acid dissociation constant pKa of less than 3.0 include inorganic acids such as sulfuric acid, hydrochloric acid, nitric acid, perchloric acid, tetrafluoroboric acid, hexafluorophosphoric acid, hydrofluoric acid and hydroiodic acid, aromatic sulfonic acids such as benzenesulfonic acid and p-toluenesulfonic acid, and aliphatic sulfonic acids (or alkanesulfonic acids) such as methanesulfonic acid and ethanesulfonic acid. Further, a polymer having a sulfonic acid group in its molecule, i.e., a polymer sulfonic acid, is also usable. Examples of the polymer sulfonic acid include polystyrene sulfonic acid, polyvinyl sulfonic acid, polyallyl sulfonic acid, poly(acrylamide-t-butylsulfonic acid), phenol sulfonic acid novolak resin, and perfluorosulfonic acid such as NAFION (registered trade name). Polyvinyl sulfuric acid is also usable as the protonic acid.

Other examples of the protonic acid to be used for the production of the electrically conductive polyaniline include some kinds of phenols such as picric acid, some kinds of aromatic carboxylic acids such as m-nitrobenzoic acid, and some kinds of aliphatic carboxylic acids such as dichloroacetic acid and malonic acid, which each have an acid dissociation constant pKa of less than 3.0.

Of the various protonic acids described above, tetrafluoroboric acid and hexafluorophosphoric acid are preferably used, because they are protonic acids containing the same anion species as an electrolyte salt (base metal salt) used for a nonaqueous electrolytic solution in a nonaqueous electrolytic secondary battery and, more specifically, they are protonic acids each containing the same anion species as an electrolyte salt (lithium salt) used for a nonaqueous electrolytic solution in a lithium secondary battery.

As described above, the electrically conductive polymer may be a polymer doped with a protonic acid anion or may be a dedoped polymer obtained by dedoping a polymer doped with a protonic acid anion. As required, the dedoped polymer may be further subjected to a reduction process.

An exemplary method for dedoping the electrically conductive polymer is such that the electrically conductive polymer doped with the protonic acid anion is neutralized with an alkali. An exemplary method for performing the reduction process after the dedoping of the electrically conductive polymer doped with the protonic acid anion is such that the electrically conductive polymer doped with the protonic acid anion is neutralized with an alkali and then dedoped, and the resulting dedoped polymer is reduced with a reducing agent.

Where the electrically conductive polymer doped with the protonic acid anion is neutralized with the alkali, for example, the electrically conductive polymer is fed into an alkali aqueous solution such as a sodium hydroxide aqueous solution, a potassium hydroxide aqueous solution or ammonia water and the resulting mixture is stirred at a room temperature or, as required, with heating to about 50° C. to about 80° C. The dedoping reaction of the electrically conductive polymer is promoted by the alkali treatment with heating, so that the dedoping can be completed in a shorter period of time.

For the production of the power storage device positive electrode, as required, a binder, an electrically conductive agent, water and the like may be further added to the electrically conductive polymer.

Particularly, an anionic material also functioning as the binder is preferred because the capacity density can be increased.

<Anionic Material>

Examples of the anionic material include anionic polymers, anionic compounds each having a relatively great molecular weight, and anionic compounds each having a lower solubility in an electrolytic solution. More specifically, a compound having a carboxyl group in its molecule is preferably used and, particularly, a polymeric polycarboxylic acid is preferably used. Where the polycarboxylic acid is used as the anionic material, the polycarboxylic acid functions as the binder as well as the dopant, thereby improving the characteristic properties of the power storage device.

Examples of the polycarboxylic acid include polyacrylic acid, polymethacrylic acid, polyvinylbenzoic acid, polyallylbenzoic acid, polymethallylbenzoic acid, polymaleic acid, polyfumaric acid, polyglutamic acid and polyasparaginic acid, among which polyacrylic acid and polymethacrylic acid are particularly preferred. These polycarboxylic acids may be used either alone or in combination.

The polycarboxylic acid may be a polycarboxylic acid of lithium-exchanged type prepared by lithium-exchanging carboxyl groups of a carboxyl-containing compound. The lithium exchange percentage is preferably 100%, but may be lower (preferably 40% to 100%) according to the conditions.

The anionic material is generally used in an amount of 1 to 100 parts by weight, preferably 2 to 70 parts by weight, most preferably 5 to 40 parts by weight, based on 100 parts by weight of the electrically conductive polymer. If the amount of the anionic material is excessively small with respect to the electrically conductive polymer, it will be impossible to provide a power storage device having a higher capacity density. If the amount of the anionic material is excessively great with respect to the electrically conductive polymer, on the other hand, the relative amount of the active substance material is reduced, making it impossible to provide a power storage device having a higher capacity density.

Besides the anionic material described above, polyvinylidene fluoride or the like, for example, may be used as the binder in combination with the electrically conductive polymer.

The electrically conductive agent is desirably an electrically conductive material which has a higher electrical conductivity, and is effective for reducing the electrical resistance between the active substances of the battery and free from change in its properties due to application of a potential in battery discharge. Generally usable examples of the electrically conductive agent include electrically conductive carbon blacks such as acetylene black and Ketjen black, and fibrous carbon materials such as carbon fibers and carbon nanotubes.

<Positive Electrode>

The power storage device positive electrode is preferably composed of a composite material including the electrically conductive polymer and the anionic material, and generally formed in a porous sheet.

The positive electrode generally has a thickness of 1 to 500 μm, preferably 10 to 300 μm. The thickness of the positive electrode is measured, for example, by means of a dial gage (available from Ozaki Mfg. Co., Ltd.) which is a flat plate including a distal portion having a diameter of 5 mm. The measurement is performed at ten points on a surface of the electrode, and the measurement values are averaged. Where the positive electrode (porous layer) is provided on a current collector to be combined with the current collector, the thickness of the combined product is measured in the aforementioned manner, and the measurement values are averaged. Then, the thickness of the positive electrode is determined by subtracting the thickness of the current collector from the average thickness of the combined product.

The power storage device positive electrode is produced, for example, in the following manner. At least the electrically conductive agent, the binder and water are added to the particles of the positive electrode active substance including the electrically conductive polymer, and the positive electrode active substance particles are sufficiently dispersed in the resulting mixture, whereby a slurry is prepared. Then, the slurry is applied on a current collector, and water is evaporated. Thus, the slurry is formed in a sheet. In this manner, the positive electrode (sheet electrode) is provided, which is a composite body configured such that a mixture layer containing the electrically conductive polymer and, as required, the anionic material and the like is provided on the current collector.

A major feature of the present invention is that the electrically conductive polymer particles have a median diameter of not greater than 5 μm, preferably not greater than 4.0 μm, particularly preferably not greater than 3.0 μm. If the median diameter of the electrically conductive polymer particles is greater than the upper limit, it will be impossible to develop a sufficient initial capacity, resulting in a lower capacity density. The lower limit of the median diameter of the electrically conductive polymer particles is generally not less than 0.01 μm, preferably not less than 0.05 μm, particularly preferably not less than 0.1 μm.

The median diameter may be measured, for example, by a laser diffraction scattering method, a dynamic light scattering method, an imaging method, an inductive diffraction grating method or the like. In the dynamic light scattering method, a common particle size distribution analyzer of dynamic light scattering type may be used for the measurement.

The electrically conductive polymer particles having a median diameter of not greater than 5 μm may be produced, for example, by preparing the electrically conductive polymer, and pulverizing the electrically conductive polymer in a solvent such as acetone or methanol by means of a JET mill pulverizer of a wet type or a dry type.

Further, a bead mill, a ball mill or an attritor of a wet type or a dry type may be used. The electrically conductive polymer may be synthesized in a particulate form having a median diameter of not greater than 5 μm, and used as it is without performing the pulverization process.

<Electrolyte Layer>

The electrolyte layer is formed from an electrolyte. For example, a sheet including a separator impregnated with an electrolytic solution or a sheet made of a solid electrolyte is preferably used. The sheet made of the solid electrolyte per se functions as a separator.

The electrolyte includes a solute and, as required, a solvent and additives. Preferred examples of the solute include compounds prepared by combining a metal ion such as a lithium ion with a proper counter ion such as a sulfonate ion, a perchlorate ion, a tetrafluoroborate ion, a hexafluorophosphate ion, a hexafluoroarsenic ion, a bis(trifluoromethanesulfonyl)imide ion, a bis(pentafluoroethanesulfonyl)imide ion or a halide ion. Specific examples of the electrolyte include LiCF₃SO₃, LiClO₄, LiBF₄, LiPF₆, LiAsF₆, LiN(SO₂CF₃)₂, LiN(SO₂C₂F₅)₂ and LiCl.

Examples of the solvent include nonaqueous solvents, i.e., organic solvents, such as carbonates, nitriles, amides and ethers, at least one of which is used. Specific examples of the organic solvents include ethylene carbonate, propylene carbonate, butylene carbonates, dimethyl carbonate, diethyl carbonate, ethyl methyl carbonate, acetonitrile, propionitrile, N,N′-dimethylacetamide, N-methyl-2-pyrrolidone, dimethoxyethane, diethoxyethane and γ-butyrolactone, which may be used either alone or in combination. A solution prepared by dissolving the solute in the solvent may be referred to as “electrolytic solution.”

<Separator>

In this embodiment, the separator can be used in a variety of forms as described above. The separator may be an insulative porous sheet which is capable of preventing an electrical short circuit between the positive electrode and the negative electrode disposed in opposed relation with the separator interposed therebetween and electrochemically stable and has a higher ionic permeability and a certain mechanical strength. Therefore, exemplary materials for the separator include paper, nonwoven fabric, porous films made of a resin such as polypropylene, polyethylene or polyimide, which may be used either alone or in combination.

<Negative Electrode>

The negative electrode is preferably produced from a metal or a negative electrode material (negative electrode active substance) capable of ion insertion/desertion. Examples of the negative electrode active substance include metal lithium, carbon materials and transition metal oxides capable of insertion and desertion of lithium ions in oxidation and reduction, silicon and tin. The negative electrode preferably has substantially the same thickness as the positive electrode.

<Positive Electrode Current Collector and Negative Electrode Current Collector>

Exemplary materials for the positive electrode current collector and the negative electrode current collector include metal foils and meshes such as of nickel, aluminum, stainless steel and copper. The positive electrode current collector and the negative electrode current collector may be formed of the same material or may be formed of different materials.

<Power Storage Device>

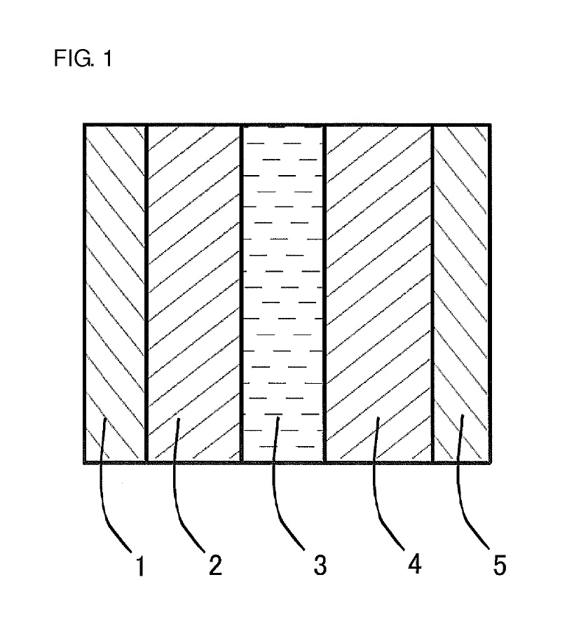

Next, the power storage device employing the power storage device positive electrode will be described. The power storage device includes, for example, the electrolyte layer 3, and the positive electrode 2 and the negative electrode 4 provided in opposed relation with the electrolyte layer 3 interposed therebetween as shown in FIG. 1. In FIG. 1, reference numerals 1 and 5 designate the positive electrode current collector and the negative electrode current collector, respectively.

The power storage device employing the power storage device positive electrode is produced, for example, in the following manner by using the negative electrode and other materials described above. The positive electrode, the separator and the negative electrode are stacked with the separator held between the positive electrode and the negative electrode to provide a stack. The stack is put in a battery container such as an aluminum laminate package, and then dried in vacuum. Subsequently, the electrolytic solution is fed into the battery container thus dried in vacuum, and an opening of the battery container package is sealed. Thus, the power storage device (laminate cell) is produced. The battery production process including the electrolytic solution feeding step and the like is performed in a glove box in an inert gas atmosphere such as an ultrapure argon gas atmosphere.

Besides the laminate cell, the power storage device may be shaped in a film form, a sheet form, a square form, a cylindrical form or a button form. In the case of the laminate cell, the positive electrode of the power storage device preferably has an edge length of 1 to 300 mm, particularly preferably 10 to 50 mm, and the negative electrode preferably has an edge length of 1 to 400 mm, particularly preferably 10 to 60 mm. The negative electrode preferably has a slightly greater size than the positive electrode.

The power storage device, like the electric double layer capacitor, has a higher weight power density and excellent cycle characteristics. In addition, the power storage device has a significantly higher weight energy density than the prior art electric double layer capacitor. Therefore, the power storage device may be a kind of a capacitor-type power storage device.

### EXAMPLES

Inventive examples will hereinafter be described in conjunction with comparative examples. However, the present invention is not limited to these examples.

The following components were prepared before the production of power storage devices according to the inventive examples and the comparative examples.

<Preparation of Electrically Conductive Polyaniline Powder>

Powder of an electrically conductive polyaniline (electrically conductive polymer) containing tetrafluoroboric acid as a dopant was prepared in the following manner. The powder herein means agglomerated particles, i.e., secondary particles generally resulting from agglomeration of primary particles. That is, 84.0 g (0.402 mol) of a tetrafluoroboric acid aqueous solution (special grade reagent available from Wako Pure Chemical Industries, Ltd.) having a concentration of 42 wt % was added to 138 g of ion-exchanged water contained in a 300-mL volume glass beaker. Then, 10.0 g (0.107 mol) of aniline was added to the resulting solution, while the solution was stirred by a magnetic stirrer. Immediately after the addition of aniline to the tetrafluoroboric acid aqueous solution, aniline was dispersed in an oily droplet form in the tetrafluoroboric acid aqueous solution, and then dissolved in water in several minutes to provide a homogeneous transparent aniline aqueous solution. The aniline aqueous solution thus provided was cooled to −4° C. or lower with the use of a cryostat chamber.

Then, 11.63 g (0.134 mol) of a powdery manganese dioxide oxidizing agent (Grade-1 reagent available from Wako Pure Chemical Industries, Ltd.) was added little by little to the aniline aqueous solution, while the mixture in the beaker was kept at a temperature of not higher than −1° C. Immediately after the oxidizing agent was thus added to the aniline aqueous solution, the color of the aniline aqueous solution turned dark green. Thereafter, the solution was continuously stirred, whereby generation of a dark green solid began.

After the oxidizing agent was added in 80 minutes in this manner, the resulting reaction mixture containing the reaction product thus generated was cooled, and further stirred for 100 minutes. Thereafter, the resulting solid was suction-filtered through No. 2 filter paper (available from ADVANTEC Corporation) with the use of a Buchner funnel and a suction bottle to provide powder. The powder was washed in an about 2 mol/L tetrafluoroboric acid aqueous solution with stirring by means of the magnetic stirrer, then washed in acetone several times with stirring, and suction-filtered. The resulting powder was dried in vacuum at a room temperature (25° C.) for 10 hours. Thus, 12.5 g of an electrically conductive polyaniline containing tetrafluoroboric acid as a dopant was provided, which was bright green powder.

<Electrical Conductivity of Electrically Conductive Polyaniline Powder>

After 130 mg of the electrically conductive polyaniline powder was milled in an agate mortar, the resulting powder was compacted into an electrically conductive polyaniline disk having a diameter of 13 mm and a thickness of 720 μm in vacuum at a pressure of 75 MPa for 10 minutes by means of a KBr tablet forming machine for infrared spectrum measurement. The disk had an electrical conductivity of 19.5 S/cm as measured by Van der Po's quad-terminal electrical conductivity measurement method.

<Preparation of Electrically Conductive Polyaniline Powder in Dedoped State>

The electrically conductive polyaniline powder provided in the doped state in the aforementioned manner was put in a 2 mol/L sodium hydroxide aqueous solution, and stirred in a 3-L separable flask for 30 minutes. Thus, the electrically conductive polyaniline powder was dedoped with the tetrafluoroboric acid dopant through a neutralization reaction. The dedoped polyaniline was washed with water until the filtrate became neutral. Then, the dedoped polyaniline was washed in acetone with stirring, and suction-filtered through No. 2 filter paper with the use of a Buchner funnel and a suction bottle. Thus, dedoped polyaniline powder was provided on the No. 2 filter paper. The resulting powder was dried in vacuum at a room temperature for 10 hours, whereby brown dedoped polyaniline powder was provided.

<Preparation of Polyaniline Powder in Reduced Dedoped State>

Next, the polyaniline power prepared in the dedoped state in the aforementioned manner was put in a phenylhydrazine methanol aqueous solution, and reduced for 30 minutes with stirring. Due to the reduction, the color of the polyaniline power turned from brown to gray. After the reaction, the resulting polyaniline powder was washed with methanol and then with acetone, filtered, and dried in vacuum at a room temperature. Thus, reduced dedoped polyaniline was provided. The median diameter of the reduced dedoped polyaniline thus provided was measured by means of a laser diffraction particle size analyzer (SALD-2100 available from Shimadzu Corporation) by using acetone as a solvent. As a result, the reduced dedoped polyaniline powder had a median diameter of 13 μm. In the following inventive examples and comparative examples, the median diameter was measured in this manner.

<Electrical Conductivity of Reduced Dedoped Polyaniline Powder>

After 130 mg of the reduced dedoped polyaniline powder was milled in an agate mortar, the resulting powder was compacted into a reduced dedoped polyaniline disk having a thickness of 720 μm in vacuum at a pressure of 75 MPa for 10 minutes by means of a KBr tablet forming machine for infrared spectrum measurement. The disk had an electrical conductivity of 5.8×10⁻³ S/cm as measured by Van der Po's quad-terminal electrical conductivity measurement method. This means that the polyaniline compound was an active substance compound having an electrical conductivity variable due to ion insertion/desertion.

<Preparation of Polycarboxylic Acid>

In ion-exchanged water, 4.4 g of polyacrylic acid (available from Wako Pure Chemical Industries, Ltd., and having a weight average molecular weight of 1,000,000) was dissolved, whereby 20.5 g of a viscous polyacrylic acid aqueous solution having a concentration of 4.4 wt % was provided. Then, 0.15 g of lithium hydroxide was added to and dissolved in the resulting polyacrylic acid aqueous solution, whereby a polyacrylic acid-lithium polyacrylate composite solution was prepared in which 50% of acrylic acid portions were lithium-exchanged.

<Preparation of Separator>

A nonwoven fabric (TF40-50 available from Hohsen Corporation and having a void percentage of 55%) was prepared.

<Preparation of Negative Electrode>

Metal lithium (rolled Li foil available from Honjo Metal Co., Ltd.) having a thickness of 50 μm was prepared.

<Preparation of Electrolytic Solution>

An ethylene carbonate/dimethyl carbonate solution containing lithium tetrafluoroborate (LiBF₄) at a concentration of 1 mol/dm³ (available from Kishida Chemical Co., Ltd.) was prepared.

### Example 1

### Preparation of Positive Electrode

The reduced dedoped polyaniline powder produced in the aforementioned manner was pulverized by means of a JET mill pulverizer of a wet type (STARBURST available from Sugino Machine Limited), whereby polyaniline powder having a median diameter of 1.2 μm was prepared. After 4 g of the polyaniline powder, 0.6 g of electrically conductive carbon black (DENKA BLACK available from Denki Kagaku Kogyo K.K.) and 4 g of water were mixed together, the resulting mixture was added to 20.5 g of the binder solution (polyacrylic acid/lithium polyacrylate composite solution). The resulting mixture was kneaded by a spatula, and ultrasonically treated for 5 minutes by an ultrasonic homogenizer. Then, a high shear force was applied to the mixture by means of FILMIX MODEL 40-40 (available from Primix Corporation) to mildly disperse the powder in the mixture. Thus, a fluid paste was provided. The paste was defoamed for 3 minutes by means of THINKY MIXER (available from Thinky Corporation). Thus, a defoamed paste was provided.

The defoamed paste was applied at a coating rate of 10 mm/sec onto an etched aluminum foil for an electric double layer capacitor (30CB available from Hohsen Corporation) with the use of a desktop automatic coater (available from Tester Sangyo Co., Ltd.) while the coating thickness was adjusted to 360 μm by a doctor blade applicator equipped with a micrometer. Then, the resulting coating was allowed to stand at a room temperature (25° C.) for 45 minutes, and dried on a hot plate at a temperature of 100° C. Thus, a polyaniline sheet electrode (positive electrode) was produced.

### Production of Power Storage Device (Lithium Secondary Battery)

A lithium secondary battery was assembled by using the polyaniline sheet electrode produced in the aforementioned manner as the positive electrode and the other materials prepared in the aforementioned manner. In the assembling of the battery, the polyaniline sheet electrode (positive electrode) and a stainless steel mesh prepared as the negative electrode current collector were dried in vacuum at 80° C. for 2 hours, and the separator was dried in vacuum at 120° C. for 3 hours. Then, the battery was assembled in a glove box (having a dew point of −100° C. therein) in an ultrapure argon gas atmosphere. The positive electrode had a size of 27 mm×27 mm, and the negative electrode had a size of 29 mm×29 mm.

### Example 2

### Production of Positive Electrode

The reduced dedoped polyaniline powder produced in the aforementioned manner was pulverized by means of a JET mill pulverizer of a wet type (STARBURST available from Sugino Machine Limited), whereby polyaniline powder having a median diameter of 2.7 μm was prepared. Then, a polyaniline sheet electrode (positive electrode) was produced in substantially the same manner as in Example 1, except that the polyaniline powder thus prepared was used.

### Production of Lithium Secondary Battery

A lithium secondary battery was produced in substantially the same manner as in Example 1, except that the polyaniline sheet electrode (positive electrode) thus produced was used instead of the polyaniline sheet electrode (positive electrode) used in Example 1.

### Example 3

### Production of Positive Electrode

The reduced dedoped polyaniline powder produced in the aforementioned manner was pulverized by means of a JET mill pulverizer of a wet type (STARBURST available from Sugino Machine Limited), whereby polyaniline powder having a median diameter of 3.4 μm was prepared. Then, a polyaniline sheet electrode (positive electrode) was produced in substantially the same manner as in Example 1, except that the polyaniline powder thus prepared was used.

### Production of Lithium Secondary Battery

A lithium secondary battery was produced in substantially the same manner as in Example 1, except that the polyaniline sheet electrode (positive electrode) thus produced was used instead of the polyaniline sheet electrode (positive electrode) used in Example 1.

### Example 4

### Production of Positive Electrode

The reduced dedoped polyaniline powder produced in the aforementioned manner was pulverized by means of a JET mill pulverizer of a wet type (STARBURST available from Sugino Machine Limited), whereby polyaniline powder having a median diameter of 4.9 μm was prepared. Then, a polyaniline sheet electrode (positive electrode) was produced in substantially the same manner as in Example 1, except that the polyaniline powder thus prepared was used.

### Production of Lithium Secondary Battery

A lithium secondary battery was produced in substantially the same manner as in Example 1, except that the polyaniline sheet electrode (positive electrode) thus produced was used instead of the polyaniline sheet electrode (positive electrode) used in Example 1.

### Comparative Example 1

### Production of Positive Electrode

The reduced dedoped polyaniline powder produced in the aforementioned manner was not pulverized by means of the wet type JET mill pulverizer, but was used as it was. The polyaniline powder had a median diameter of 8.9 μm. Then, a polyaniline sheet electrode (positive electrode) was produced in substantially the same manner as in Example 1, except that the polyaniline powder thus prepared was used.

### Production of Lithium Secondary Battery

A lithium secondary battery was produced in substantially the same manner as in Example 1, except that the polyaniline sheet electrode (positive electrode) thus produced was used instead of the polyaniline sheet electrode (positive electrode) used in Example 1.

### Comparative Example 2

### Production of Positive Electrode

The reduced dedoped polyaniline powder produced in the aforementioned manner was granulated by a dry ball mill (P-6 available from Fritsch GMbh). The resulting polyaniline powder had a median diameter of 18.4 μm. Then, a polyaniline sheet electrode (positive electrode) was produced in substantially the same manner as in Example 1, except that the polyaniline powder thus prepared was used.

### Production of Lithium Secondary Battery

A lithium secondary battery was produced in substantially the same manner as in Example 1, except that the polyaniline sheet electrode (positive electrode) thus produced was used instead of the polyaniline sheet electrode (positive electrode) used in Example 1.

The lithium secondary batteries produced in Examples and Comparative Examples were evaluated for characteristic properties based on the following criteria. The results are also shown below in Table 1.

### Weight Capacity Density

The lithium secondary batteries produced in the aforementioned manner were each allowed to stand still in a thermostat chamber kept at 25° C. By means of a battery charge/discharge device (SD8 available from Hokuto Denko Corporation), measurement was performed in a constant current and constant voltage charge/constant current discharge mode. The charge termination voltage was set to 3.8 V. After the voltage reached 3.8 V through a constant current charge process, a constant voltage charge process was further performed at 3.8V until the current value became 20% of a current value for the constant current charge process, and the resulting capacity was defined as a charge capacity. Thereafter, a constant current discharge process was performed to a discharge termination voltage of 2.0 V, and a weight capacity density obtained in the second cycle was measured. The weight capacity density was a capacity density per net weight of the electrically conductive polyaniline for use as the positive electrode active substance.

### Measurement of Initial Capacity Developing Percentage (%)

The initial capacity developing percentage of each of the laminate cells produced in the aforementioned manner was calculated from the following expression (1), wherein the weight capacity density at the first cycle is a weight capacity density obtained at the first cycle of the five cycles in the measurement of the weight capacity density:

Initial capacity developing percentage (%)=(Weight energy density at first cycle/Weight energy density at fifth cycle)×100 (1)

TABLE 1

| | | | Initial |
|---|---|---|---|
| | | Weight | capacity |
| | Median | capacity | developing |
| | diameter | density | percentage |
| | (μm) | (Ah/kg) | (%) |
| Example 1 | 1.2 | 172 | 105.0 |
| Example 2 | 2.7 | 163 | 93.0 |
| Example 3 | 3.4 | 165 | 84.7 |
| Example 4 | 4.9 | 160 | 80.0 |
| Comparative | 8.9 | 150 | 44.9 |
| Example 1 | | | |
| Comparative | 18.4 | 142 | 3.0 |
| Example 2 | | | |

The results shown in Table 1 indicate that the weight capacity density and the initial capacity developing percentage were higher in Examples 1 to 4 in which the electrically conductive polymer particles having a median diameter of not greater than 5 μm were used as the positive electrode active substance than in Comparative Examples 1 and 2 in which the electrically conductive polymer particles having a median diameter of greater than 5 μm were used as the positive electrode active substance.

While specific forms of the embodiment of the present invention have been shown in the aforementioned inventive examples, the inventive examples are merely illustrative of the invention but not limitative of the invention. It is contemplated that various modifications apparent to those skilled in the art could be made within the scope of the invention.

The power storage device employing the power storage device positive electrode described above can be used for the same applications as the prior art secondary batteries, for example, for mobile electronic apparatuses such as mobile PCs, mobile phones and personal data assistants (PDAs), and for driving power sources for hybrid electric cars, electric cars and fuel battery cars.

### EXPLANATION OF REFERENCES

1 POSITIVE ELECTRODE CURRENT COLLECTOR
2 POSITIVE ELECTRODE
3 ELECTROLYTE LAYER
4 NEGATIVE ELECTRODE
5 NEGATIVE ELECTRODE CURRENT COLLECTOR

1. A power storage device positive electrode comprising an electrically conductive polymer as a positive electrode active substance, wherein the electrically conductive polymer is present in a particulate form having a median diameter of not greater than 5 μm.

2. The power storage device positive electrode according to claim 1, wherein the electrically conductive polymer is at least one of a polyaniline and a polyaniline derivative.

3. A production method for a power storage device positive electrode, comprising the steps of:
adding at least an electrically conductive agent, a binder and water to particles of a positive electrode active substance including an electrically conductive polymer to prepare a slurry; and
forming the slurry into a sheet;
wherein the electrically conductive polymer is electrically conductive polymer particles prepared by pulverizing the electrically conductive polymer to a median diameter of not greater than 5 μm by means of a JET mill pulverizer.

4. The production method for the power storage device positive electrode according to claim 3, wherein the electrically conductive polymer is at least one of a polyaniline and a polyaniline derivative.

5. A positive electrode active substance for a power storage device, comprising particles of an electrically conductive polymer having a median diameter of not greater than 5 μm.

6. A method for producing a positive electrode active substance including an electrically conductive polymer for a power storage device, the method comprising the step of using particles of the electrically conductive polymer prepared by pulverizing the electrically conductive polymer to a median diameter of not greater than 5 μm by means of a JET mill pulverizer.

7. The method for producing the positive electrode active substance for the power storage device according to claim 6, wherein the electrically conductive polymer is at least one of a polyaniline and a polyaniline derivative.

8. A power storage device comprising:
an electrolyte layer; and
a positive electrode and a negative electrode provided in opposed relation with the electrolyte layer interposed therebetween;
wherein the positive electrode contains electrically conductive polymer particles having a median diameter of not greater than 5 μm as a positive electrode active substance.

9. The power storage device according to claim 8, wherein the electrically conductive polymer is derivative at least one of a polyaniline and a polyaniline derivative.
